(19) United States
(12) Patent Application Publication
(10) Pub. No.: US 2013/0242508 A1
(43) Pub. Date: Sep. 19, 2013

(54) ELECTRICAL SWITCH CABINET

(71) Applicant: ABB AG, Mannheim (DE)

(72) Inventor: Stefan BEIER, Buhl-Balzhofen (DE)

(73) Assignee: ABB AG, Mannheim (DE)

(21) Appl. No.: 13/889,066

(22) Filed: May 7, 2013

Related U.S. Application Data
(63) Continuation of application No. PCT/EP2011/005201, filed on Oct. 17, 2011.

(30) Foreign Application Priority Data
Nov. 9, 2010 (DE) 10 2010 050 665.6

(51) Int. Cl. H02B 1/38; H02B 1/28

(52) U.S. Cl. CPC H02B 1/38; H02B 1/28
USPC 361/724; 29/11; 156/247

(57) ABSTRACT

An exemplary electrical switch cabinet for use in the low voltage range with voltages up to 500 V and electric currents up to 63 A, is constructed as a wall hung cabinet for surface or recessed mounting or as a standing cabinet, from a rear wall and side wall parts connected thereto. The cabinet can include at least one movable front door, and can be provided with internal fittings for the connection of switching devices arranged in the switch cabinet. The side wall parts and the rear wall are modularly configured and rigidly connected to one another, and the at least one movable front door can be guided in grooves through straps.

### RELATED APPLICATION(S)

This application claims priority as a continuation application under 35 U.S.C. §120 to PCT/EP2011/005201, which was filed as an International Application on Oct. 17, 2011 designating the U.S., and which claims priority to German Application 10 2010 050 665.6 filed in Germany on Nov. 9, 2010. The content of each prior application is hereby incorporated by reference in its entirety.

### FIELD

The disclosure relates to an electrical switch cabinet for use in the low-voltage range. The switch cabinet can be formed as a wall cabinet for surface or recessed mounting or as a stand-alone cabinet from a rear wall and from side wall parts which are connected to said rear wall. Alternatively, the switch cabinet can be formed with from at least one movable front door and provided with internal components for connecting switching devices which are arranged in the switch cabinet.

### BACKGROUND INFORMATION

The rated current is known as the current which a plug connector can simultaneously continuously (not intermittently) conduct through all the contacts, without the permissible upper limit temperature being exceeded in the process.

Known switch cabinets can be used as empty enclosures for electrical and/or electronic operating means and equally provide protection against dust and water (protection classification, IP protection classes in accordance with DIN EN 60529) for the components in the interior, mounting and structuring of the interior structure by means of supporting rails and mounting plates and subdivision into power and control regions, protection against overheating and against electromagnetic influences, protection against mechanical influences, vandalism and earthquakes.

For the surrounding area, switch cabinets form a shield against electromagnetic emissions, protection against voltage-carrying parts with a dangerous voltage being touched (protection classes: protective grounding or protective insulation) and protection against fire.

Some switch cabinets have windows for reading/identifying switching states or measurement values. Many switch cabinets likewise have an emergency off button or a suitable main switch on the outside for stopping the associated electrical system in the event of a hazardous situation.

Switch cabinets are produced from sheet metal or plastic, depending on their size and intended application, wherein switch cabinets which are composed of sheet metal are formed, as far as possible, as a single stamped and bent part and are mechanically joined to one another at the connecting edges, for example by spot or linear welding.

Apart from the fact that this manner of production specifies large sheet-metal precursors so that the relevant switch cabinet can be produced virtually in one piece, handling of such large metal sheets can be complicated and laborious.

### SUMMARY

An exemplary electrical switch cabinet for use in the low-voltage range is disclosed, comprising: a rear wall; side wall parts connected to said rear wall; at least one movable front door connected to the side wall parts; and internal components for connecting switching devices which are arranged in the switch cabinet, wherein the side wall parts and the rear wall are of modular design and are rigidly connected to one another and the at least one movable front door can be guided in grooves.

An exemplary method for producing an electrical switch cabinet is dislcosed, comprising: providing side wall parts with connecting edges and rear wall parts with connecting edges; associating two adjoined connecting edges of wall parts with one another; removing a protective film or foil from one side of the double-sided adhesive tape and the connecting edges of a respective wall part are provided with the double-sided adhesive tape; removing the protective film or foil from an other side of the adhesive tape and an adhesive surface is exposed; pressing the adhesive edge of the respective relevant wall part against the exposed adhesive surface, and repeating the removing and pressing steps until all of the adhesive edges which are associated with one another are connected to one another.

An exemplary electrical switch cabinet for use in the low-voltage range is disclosed, comprising: a rear wall; side wall parts connected to said rear wall; at least one movable front door connected to the side wall parts; and internal components for connecting switching devices which are arranged in the switch cabinet, wherein the side wall parts and the rear wall are of modular design and are rigidly connected to one another and the at least one movable front door can be guided by straps.

### BRIEF DESCRIPTION OF THE DRAWINGS

Exemplary embodiments of the present disclosure, advantageous refinements of and improvements to the disclosure and advantages resulting from the disclosure are intended to be explained and described in greater detail with reference to an exemplary embodiment of the disclosure which is illustrated in the appended drawing, in which:

FIG. 1 shows a plan view of a frame which is completely assembled from side wall parts in accordance with an exemplary embodiment of the present disclosure;

FIG. 2 shows a side view of the frame according to FIG. 1 with an enlarged illustration of a detail of the adhesive tape which is fitted thereto in accordance with an exemplary embodiment of the present disclosure; and

FIG. 3 shows the illustration of the detail from FIG. 2 on a more enlarged scale in accordance with an exemplary embodiment of the present disclosure.

### DETAILED DESCRIPTION

Exemplary embodiments of the present disclosure provide a switch cabinet of the type cited in the introductory part which is of simple design and is easy to handle.

The exemplary embodiments disclosed herein also provide for the side wall parts and the rear wall to be of modular design and to be rigidly connected to one another and for it to be possible for the at least one movable front door to be guided in grooves or by means of straps. “Of modular design” is intended to mean that the respective individual wall parts are punched-out and correspondingly bent, with the result that they can be connected to one another by means of integrally formed connecting edges and/or connecting surfaces.

In this way, sheet-metal modules of different sizes which are punched-out and bent can be produced for stock, and the respective wall parts for the relevant switch cabinet can be taken from this stock and combined to form the desired switch cabinet.

Exemplary embodiments of the present disclosure provide a manner of assembling and connecting the individual wall modules to form a complete electrical switch cabinet, for the side wall parts and the rear wall to be welded to one another, and possibly for the at least one movable front door to be guided in grooves which are arranged on the relevant side wall parts or to be connected in an articulated manner by means of straps which are welded to the relevant side wall parts.

The at least one exemplary front door, as described in the present disclosure can be connected in an articulated manner in each case by means of an adhesive tape or strap hinge, which is attached, for example, by means of screws or rivets. Exemplary embodiments described herein can also extend to electrical switch cabinets of the kind which manage without a front door. In such cases, the exemplary embodiments of the present disclosure can relate to the switch cabinet without a front door.

Other exemplary embodiments of the present disclosure provide producing a complete electrical switch cabinet, for the side wall parts and the rear wall to be connected to one another by a rivet connection, and for the at least one movable front door to be guided in grooves which are arranged on the relevant side wall parts or to be connected in an articulated manner by means of straps which are riveted to the relevant side wall parts.

According to another exemplary embodiment of the disclosure, the side wall parts and the rear wall can be connected to one another by an adhesive connection, and for the at least one movable front door can be guided in grooves which are arranged on the relevant side wall parts or can be connected in an articulated manner by means of strap hinges which are connected to the relevant side wall parts by a screw, rivet or adhesive connection.

The exemplary connection as described in the present disclosure, it has proven expedient, both in respect of the production processes and for later use of the electrical switch cabinet, for the adhesive connection to be formed by a double-sided adhesive tape which is initially provided with a protective film or foil on both sides, said protective film or foil being removed beforehand in order to establish the respective adhesive connection.

According to another exemplary embodiment of the disclosure, a high-strength adhesive tape which is based on acrylic is provided for the adhesive connection, wherein the high-strength adhesive tape which is provided for use as an adhesive tape can have a support material which is coated with acrylate adhesive on both sides.

Exemplary embodiments of the present disclosure, provide an electrical switch cabinet having the high-strength acrylate adhesive tape which is provided for use as an adhesive tape has a closed-cell acrylic foam as the support material.

Exemplary embodiments disclosed herein also provide for the high-strength adhesive tape which is provided for the adhesive connection to be applied on uncoated and on coated surfaces, for example on painted or zinc-plated surfaces.

Furthermore, an exemplary embodiment of the present disclosure includes the high-strength adhesive tape which is provided for the adhesive connection is highly resistant to weathering influences and, as an alternative or in addition, is highly resistant to plasticizers and/or solvents.

Yet another exemplary embodiment of the electrical switch cabinet according to the disclosure includes a high-strength adhesive tape which is provided for the adhesive connection is highly temperature-resistant.

Therefore, the adhesive tape is firstly intended to connect the individual wall parts to one another and hold said individual wall parts together. However, secondly, said adhesive tape is also intended to fulfill the specifications for complying with certain protection classifications (IP) and other specifications by, on account of its non-conductive properties, also acting as an insulator.

In yet another exemplary embodiment of the disclosure, the adhesive tape can also be used in combination with screws, rivets or further connection options.

An exemplary embodiment of the present disclosure includes production method for an electrical switch cabinet of the above-described type that allows for producing an electrical switch cabinet in as simple a manner as possible and without special apparatuses.

The exemplary production method for producing an electrical switch cabinet is the side wall parts provides for producing the relevant switch cabinet, and the rear wall with connecting edges, in that the connecting edges are preliminarily positioned in an interlocking manner (by lugs in a positive form and notches in a negative form). In each case two connecting edges of wall parts which adjoin one another are associated with one another. The protective film or foil is initially removed from one side of the double-sided adhesive tape and the connecting edges of a wall part are provided with the double-sided adhesive tape. The protective film or foil is then removed from the other side of the adhesive tape and an adhesive surface is exposed, in that the adhesive edge of the relevant wall part is pressed against the exposed adhesive surface. This process is repeated until all of the adhesive edges which are associated with one another are connected to one another, wherein the groove-like guides for the at least one front door, which can be moved and is guided in said guides, can be adhesively bonded to the relevant wall parts by means of the high-strength adhesive tapes, or wherein, as an alternative, the strap hinges for the at least one movable front door can be adhesively bonded to the relevant wall parts through the high-strength adhesive tapes.

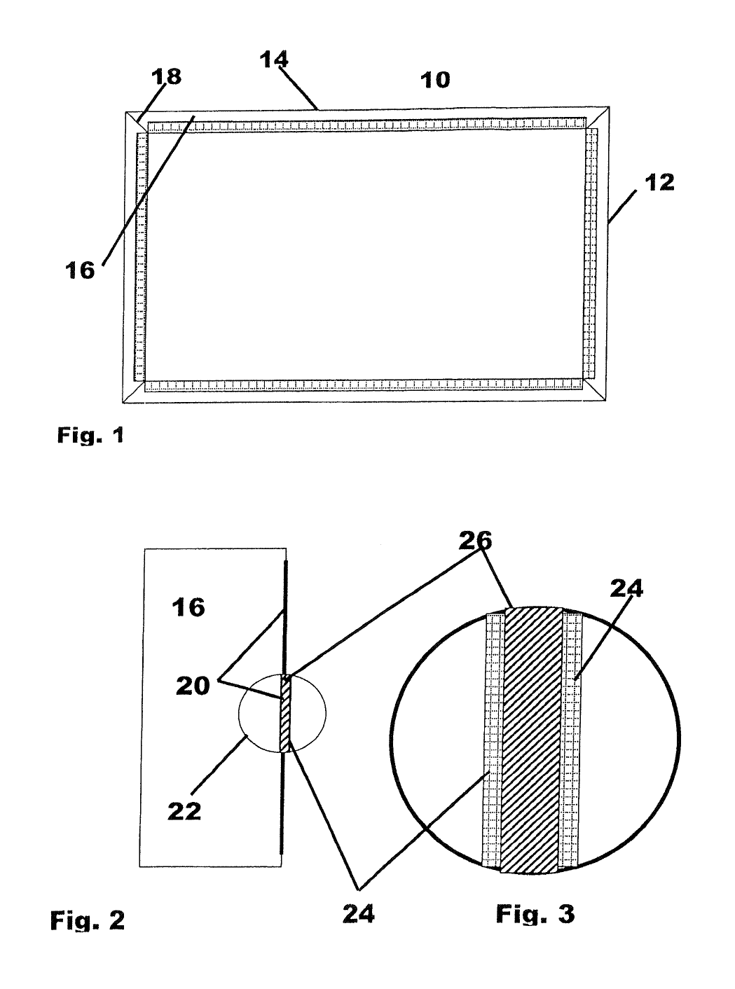

FIG. 1 shows a plan view of a frame which is completely assembled from side wall parts in accordance with an exemplary embodiment of the present disclosure. As shown in FIG. 1, the respective side wall parts 12, 14 are each provided with folds 16 and with miter cuts 18, with the result that they are firstly provided with an L-shaped cross section and secondly can be joined to one another in a fitting manner, wherein adjacent side wall parts 12, 14 butt against one another at the miter cuts.

After the punched-out and folded side wall parts 12, 14 and the other sheet-metal parts, for example, rear wall and front door, are produced, the parts are coated with paint or another coating material in order to thus protect the side wall parts 12, 14 and the other sheet-metal parts against corrosion and to prepare them in respect of the respectively intended protection class of the relevant switch cabinet.

After coating is complete, a strip of the adhesive tape 20, which is in the form of a double-sided adhesive tape, is in each case applied onto the fold, with the result that, in the case of the example shown in FIG. 1, the rear wall (not shown here) of the switch cabinet can be connected to the frame.

FIG. 2 shows a side view of the frame according to FIG. 1 with an enlarged illustration of a detail of the adhesive tape which is fitted thereto in accordance with an exemplary embodiment of the present disclosure. FIG. 2 illustrates a view of the left-hand side of the exemplary frame 10 which is shown in FIG. 1.

As shown in FIG. 2, as in FIG. 1, the large surface which forms the side wall part 16 is denoted by reference numeral 16 and the applied strip of the double-sided adhesive tape is denoted by reference numeral 20.

For the purpose of illustrating the design of the provided double-sided adhesive tape 20 which is provided as a high-strength adhesive tape, an enlarged illustration 22 of a detail is provided in FIG. 2, the illustration being shown on an enlarged scale in FIG. 3.

FIG. 3 shows the illustration of the detail from FIG. 2 on a more enlarged scale in accordance with an exemplary embodiment of the present disclosure. FIG. 3 shows that the provided adhesive tape 20 is constructed from three layers and consists of two adhesive layers 24 and a support layer 26 which is located between said adhesive layers. A protective film or foil (not shown in any detail here) is in each case further additionally provided on said adhesive layers, said protective films or foils each being arranged on the adhesive layers and being removed before the respective adhesive bonding.

The support layer 26 can be formed from a flexible closed-cell foam which is able to compensate for slight measurement tolerances, with the result that an adhesive connection which is produced in such a way ensures a connection which is not only permanently mechanically fixed but also uniform.

When the frame 10 is combined with the rear wall, at least one front door is attached, said front door either being guided in grooves or being connected in an articulated manner by means of straps (hinges) depending on specifications of the arrangement.

In this case, the grooves or the relevant strap hinges are selectively connected to the frame, and/or the latter is also selectively connected to the at least one front door, by means of screws, rivets or adhesive tape.

Thus, it will be appreciated by those skilled in the art that exemplary embodiments of the present disclosure can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Frame
12 Side wall part
14 Side wall part
16 Fold
18 Miter cut edge
20 Adhesive tape strip
22 Enlarged illustration of a detail
24 Adhesive layer
26 Support layer

What is claimed is:

1. An electrical switch cabinet for use in the low-voltage range, comprising:
a rear wall;
side wall parts connected to said rear wall;
at least one movable front door connected to the side wall parts; and
internal components for connecting switching devices which are arranged in the switch cabinet,
wherein the side wall parts and the rear wall are of modular design and are rigidly connected to one another and the at least one movable front door can be guided in grooves.

2. The electrical switch cabinet as claimed in claim 1, wherein the side wall parts and the rear wall are welded to one another, and the at least one movable front door is guided in grooves which are arranged on the relevant side wall parts.

3. The electrical switch cabinet as claimed in claim 1, wherein the side wall parts and the rear wall are connected to one another by a rivet connection, and the at least one movable front door is guided in grooves which are arranged on the relevant side wall parts.

4. The electrical switch cabinet as claimed in claim 1, wherein the side wall parts and the rear wall are connected to one another by an adhesive connection, and the at least one movable front door is guided in grooves which are arranged on the relevant side wall parts.

5. The electrical switch cabinet as claimed in claim 4, wherein the adhesive connection is formed by a double-sided adhesive tape which is provided with a protective film or foil on both sides.

6. The electrical switch cabinet as claimed in claim 4, wherein a high-strength adhesive tape provides the adhesive connection.

7. The electrical switch cabinet as claimed in claim 6, wherein the high-strength adhesive tape comprises acrylic.

8. The electrical switch cabinet as claimed in one of claim 4, wherein the high-strength adhesive tape which is used as an adhesive tape has a support material which is coated with acrylate adhesive on both sides.

9. The electrical switch cabinet as claimed in claim 8, wherein the high-strength acrylate adhesive tape which is used as an adhesive tape has a closed-cell foam as the support material.

10. The electrical switch cabinet as claimed in claim 4, wherein the high-strength adhesive tape which provides the adhesive connection is configured for application on coated surfaces.

11. The electrical switch cabinet as claimed in claim 10, wherein the coated surfaces comprise painted surfaces.

12. The electrical switch cabinet as claimed in claim 4, wherein the high-strength adhesive tape which provides the adhesive connection is highly resistant to weathering influences.

13. The electrical switch cabinet as claimed in claim 4, wherein the high-strength adhesive tape which provides the adhesive connection is highly resistant to at least one of plasticizers and solvents.

14. The electrical switch cabinet as claimed in claim 1, wherein the high-strength adhesive tape which provides the adhesive connection is highly temperature-resistant.

15. A method for producing an electrical switch cabinet, comprising:
providing side wall parts with connecting edges and rear wall parts with connecting edges;
associating two adjoined connecting edges of wall parts with one another;
removing a protective film or foil from one side of the double-sided adhesive tape and the connecting edges of a respective wall part are provided with the double-sided adhesive tape;
removing the protective film or foil from an other side of the adhesive tape and an adhesive surface is exposed;
pressing the adhesive edge of the respective relevant wall part against the exposed adhesive surface, and
repeating the removing and pressing steps until all of the adhesive edges which are associated with one another are connected to one another.

16. The method as claimed in claim 15, comprising:
adhesively bonding groove-like guides for at least one front door, which can be moved and is guided in said guides, to the relevant wall parts by means of the high-strength adhesive tapes.

17. The method as claimed in claim 15, comprising:
fixing strap hinges for at least one movable front door to the relevant wall parts through screws or rivets, or adhesively bonded through high-strength adhesive tapes.

18. An electrical switch cabinet for use in the low-voltage range, comprising:
a rear wall;
side wall parts connected to said rear wall;
at least one movable front door connected to the side wall parts; and
internal components for connecting switching devices which are arranged in the switch cabinet,
wherein the side wall parts and the rear wall are of modular design and are rigidly connected to one another and the at least one movable front door can be guided by straps.

19. The electrical switch cabinet as claimed in claim 18, wherein the side wall parts and the rear wall are welded to one another, and the at least one movable front door is connected in an articulated manner by straps which are welded to the relevant side wall parts.

20. The electrical switch cabinet as claimed in claim 18, wherein the side wall parts and the rear wall are connected to one another by a rivet connection, and in that the at least one movable front door is connected in an articulated manner by straps which are riveted to the relevant side wall parts.

21. The electrical switch cabinet as claimed in claim 18, wherein the side wall parts and the rear wall are connected to one another by an adhesive connection, and in that the at least one movable front door is connected in an articulated manner by strap hinges which are connected to the relevant side wall parts by a screw, rivet, or adhesive connection.
